(19) United States
(12) Patent Application Publication
(10) Pub. No.: US 2005/0192715 A1
(43) Pub. Date: Sep. 1, 2005

(54) Back warning system for vehicle

(76) Inventor: Ho-Kyung Kim, Youngin-si (KR)

Correspondence Address: MORGAN & FINNEGAN, L.L.P., 3 World Financial Center, New York, NY, 10281-2101, US

(21) Appl. No.: 10/920,100

(22) Filed: Aug. 17, 2004

(30) Foreign Application Priority Data
Aug. 19, 2003 (KR) 57186/2003

(51) Int. Cl. G06F 7/00

(52) U.S. Cl. 701/1

(57) ABSTRACT

The present invention relates to a back warning system for a vehicle. In the present invention, an object that needs an alarm is fully detected and an object that does not need an alarm are accurately detected and recognized using an internal type programmable reference voltage module that is installed in the interior of the CPU and is capable of generating various reference voltage values based on an input program constant value. Therefore, in the present invention, a tuning work is quickly achieved. A tuning work can be easily performed as compared to a conventional back warning system for a vehicle using an external comparator installed independently from a CPU. It is possible to significantly decrease the time needed for a tuning work. Actually, the time can be decreased from about 30 days to one day.

### BACKGROUND OF THE INVENTION

1. Field of the Invention

The present invention relates to a back warning system for a vehicle, and in particular to a back warning system for a vehicle implemented using an ultrasonic wave sensor.

2. Description of the Background Art

A back warning system for a vehicle is configured to detect a certain obstacle such as a road stop block, a center separator, an electric pole, etc. using four ultrasonic sensors installed at a rear bumper of a vehicle for thereby warning a detected obstacle to a driver.

As shown in FIG. 1, a conventional back warning system for a vehicle includes a plurality of ultrasonic sensors 10 formed of a transmitter that radiates an ultrasonic wave in response to a driving signal and a receiver that receives a signal reflected by an object; a driving circuit 20 that transfers a driving signal to each ultrasonic wave sensor 10; a reflection driving circuit 30 that operates together with the driving circuit 20 and receives a reflection signal from each ultrasonic wave sensor 10, a bandwidth filter 40 that filters a reflection signal of each ultrasonic wave sensor 10 received by the reflection driving circuit 30 to a certain frequency bandwidth; an amplification circuit 50 that amplifies a reflection signal filtered to the same frequency bandwidth as the frequency bandwidth of the bandwidth filter 40 to a certain amplification ratio; a wave detection circuit 60 that wave-detects a reflection signal passed through the amplification circuit 50; a comparator 70 that compares a detected reflection signal with a reference voltage value and outputs a high signal when the voltage value of the reflection signal is higher than a reference voltage value; and a central processing unit (CPU) 80 that outputs a driving signal for driving each ultrasonic wave sensor 10 and controls the operations of the driving circuit 20 and the reflection driving circuit 30 and outputs an object warning signal to a warning apparatus 81 when a high signal is inputted from the comparator for thereby generating a certain alarm.

As shown in FIG. 5, the ultrasonic wave sensor 10 includes a switching unit 12 that includes a transistor Q1 turned on and off in response to a driving signal of the CPU 80 inputted through a connector 11; a transformer circuit 13 that includes a transformer T1 outputting an ultrasonic wave oscillation signal increased by a transformation ratio as the transistor Q1 is turned on and off; an ultrasonic wave transceiver 14 that is driven by an ultrasonic wave oscillation signal of the transformer T1 and radiates an ultrasonic wave of a certain frequency and receives a signal reflected from an object; a clamping circuit 15 that clamps a reflection signal received through the ultrasonic wave transceiver 14; and an amplification circuit 16 that amplifies the clamped reflection signal based on multiple steps and outputs through the connector 111.

As shown in FIG. 3, the comparator 70 includes a reference signal level adjusting circuit 71 that includes resistors R1, R2 and R3 and condensers C1 and C2; and an OP amplifier 72 that includes an input terminal of a reflection signal wave-detected by the wave detection circuit 60 and an input terminal of a reference signal of which a signal level is adjusted by the reference signal level adjusting circuit 71, and outputs a high signal when the voltage value of the reflection signal is higher than the voltage value of the reference signal.

In the conventional back warning system for a vehicle, the ultrasonic wave sensor 10 radiates an ultrasonic wave based on a control of the CPU 80 and receives a reflection signal. The reflection driving circuit 30 receives the reflection signal based on a control of the CPU 80. The bandwidth filter 40 passes only a desired frequency bandwidth is passed from the received reflection signal, and the amplification circuit 50 amplifies the signal. The wave detection circuit 60 wave-detects the amplified signal. The CPU 80 judges whether there is a certain object within a detection range of the sensor 10 as a result of the comparison that the comparator 70 compares the reflection signal with a reference signal. A certain alarm is outputted through a warning apparatus 81.

At this time, the voltage value of the reflection signal is compared with a reference voltage values of the external comparator 70 that includes the reference signal level adjusting circuit 71 installed independently from the CPU 80 and including the resistors R1, R2 and R3 and the condensers C1 and C2 and the OP amplifier 72. When the voltage value of the reflection signal is higher than the reference voltage value of the external comparator 70, the CPU 80 judges that there is a certain obstacle in a detection range of the ultrasonic wave sensor 10 installed in the rear side of the vehicle for thereby generating an alarm.

In the road stop block 90 of FIG. 4, as shown in FIG. 7, when the waveform (I) of the road stop block of which the voltage value is higher than the reference signal waveform (R) of the comparator is inputted into the comparator 70, the CPU 80 judges that there is a road stop block 90 in a detection range of the ultrasonic wave sensor 10 installed in the rear side of the current vehicle for thereby generating an alarm.

For reference, FIG. 7 is an oscilloscope view with respect to a driving signal waveform (D) of the ultrasonic wave sensor 10 of the CPU 80 based on the reference line A having a signal level of 5.8V per 1 ms, a reference signal waveform (R) of the comparator 70 based on the reference line B having a signal level of 1.00V per 1 ms, and an input signal (reflection signal) waveform (I). As shown therein, the object is detected after 2 ms with respect to a start-up time of the ultrasonic wave sensor 10.

Actually, as shown in FIG. 2, in the ultrasonic wave sensor 10 having an integral transceiver, since the output terminal of the transformer T1 of the transformation circuit 13 and the output terminal of the reflection signal of the ultrasonic wave transceiver 14 are formed in same at the point P1 of FIG. 2, the driving signal D of FIG. 7 is particularly voltage-increased and transferred to the ultrasonic transceiver 14 through the output terminal of the transformer T1 The signal is clamped and amplified in an overlap with the reflection signal received at the point P1 and is inputted into the comparator 70 through the reflection driving circuit 30, the bandwidth filter 40, the amplification circuit 50, and the wave detection circuit 60. Therefore, the ultrasonic wave sensor 10 of which the transceiver is integrally formed is able to detect the object after 1.4 ms-2 ms at the time in which the transmission and receiving signals are not overlapped after the start-up time, namely, with respect to the start-up time of the ultrasonic wave sensor 10.

However, in the conventional back warning system for a vehicle that uses the external comparator 70 installed independently from the CPU 80, when the voltage value of the detection signal of the ultrasonic wave sensor 10 is even slightly higher than the reference voltage value of the comparator 70 due to a signal reflected by a certain obstacle, not an obstacle such as a road stop block, a center separator, an electric pole, etc. that actually needs an alarm, for example, as shown in FIG. 4, the gravels 91 provided in the road stop block 90, the gravel road 92 of FIG. 5, and the gravels 93 or soil 94 provided in the off-road with protrusions as shown in FIG. 6, the conventional back warning system for a vehicle may generate alarms.

As shown in FIG. 4, when the gravel detection signal waveform (I′) of which the voltage value is even slightly higher than the reference signal waveform R of the comparator 70 (FIG. 8) with respect to the gravels 91 provided in the road stop block 90 is inputted into the comparator 70, the CPU 80 of the conventional back warning system for a vehicle erroneously judges that there is a certain obstacle in the detection range of the ultrasonic wave sensor 10 of the rear side of the vehicle such as a road stop block 90 for thereby generating an error alarm.

Therefore, in order to overcome the above problems, in the conventional art, a tuning work is performed for adjusting the reference voltage value of the comparator 70 installed independently from the CPU 80. In the above tuning work, the values of the resistors R1, R2 and R3 of the reference signal level adjusting circuit 71 of the comparator 70 and the capacitances of the condensers C1 and C2 are properly varied, so that the inclination of the reference signal waveform R of the comparator 70 of FIGS. 7 and 8 is changed. Therefore, a reference signal waveform R′ having a new inclination is made.

However, in the above tuning work, when the inclination of the reference signal time constant number curve of the external comparator 70 installed independently from the CPU 80 is changed, a certain obstacle (for example, road stop block, road separator, electric pole, etc.) that actually needs an alarm is not detected. Namely, it is impossible to detect the road stop block 90 corresponding to the road stop block detection waveform (I) based on the reference signal waveform R′ of FIG. 9.

Actually, in the tuning work in which the inclination of the time constant number curve of the external comparator 70 installed independently from the CPU 80 is changed in order to enough detect the obstacles (road stop block, center separator, electric pole, etc.) that actually need an alarm and in order to prevent an error alarm due to the gravel road 92 of FIG. 5 and the gravels 93 and the soil 93 provided in the off road with high protrusions as shown in FIG. 6, the above tuning work should be repeatedly performed a few tens of times. Therefore, the tuning work is very hard (more than 30 days).

### SUMMARY OF THE INVENTION

Accordingly, it is an object of the present invention to overcome the problems encountered in the conventional art.

It is another object of the present invention to provide a back warning system for a vehicle capable of enough detecting a certain obstacle that actually needs an alarm using an internal programmable reference voltage module installed in the interior of a CPU and configured to generate various reference voltage values based on input program constant values. In addition, it is possible to easily recognize a certain obstacle that actually does not need an alarm and to easily and fast perform a tuning work.

### BRIEF DESCRIPTION OF THE DRAWINGS

The present invention will become better understood with reference to the accompanying drawings which are given only by way of illustration and thus are not limitative of the present invention, wherein:

FIG. 1 is a block diagram of a conventional warning system for a vehicle;

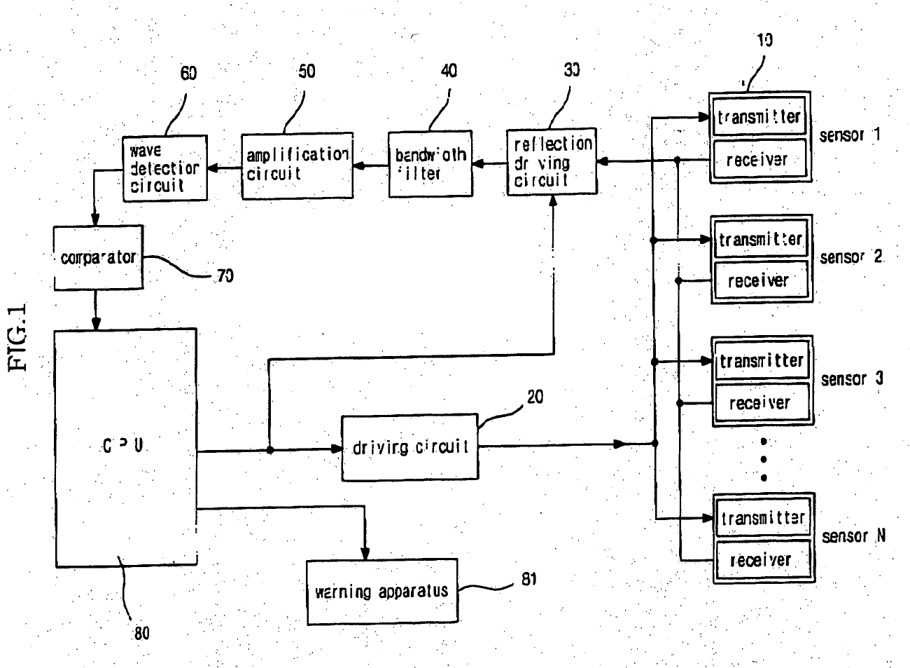

FIG. 2 is a circuit diagram of an ultrasonic wave sensor of FIG. 1;

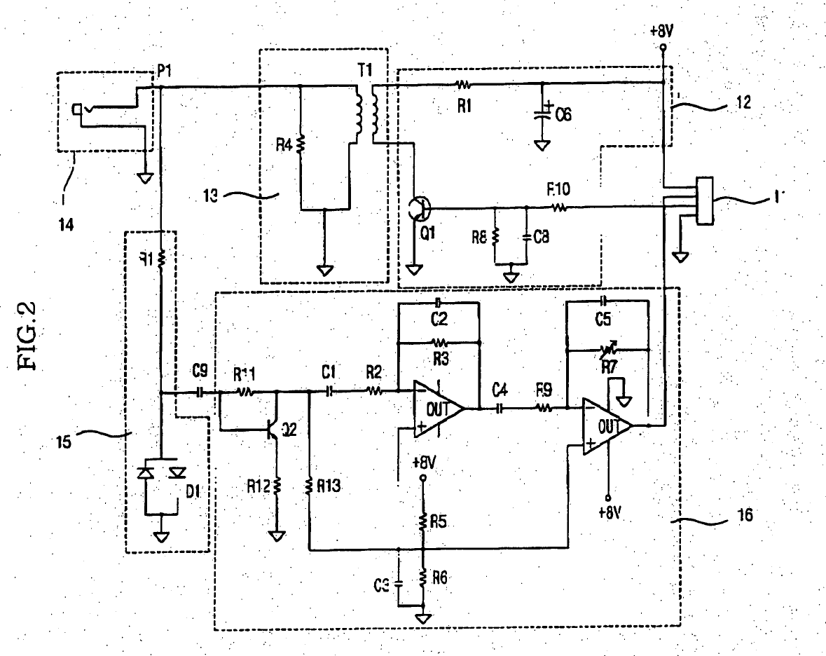

FIG. 3 is a circuit diagram of a comparator of FIG. 1;

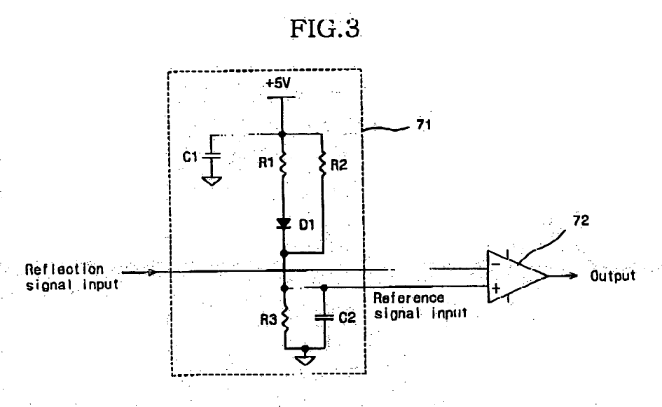

FIG. 4 is a perspective view illustrating a state that gravels are provided in a road separator that needs a back warning;

FIG. 5 is a perspective view illustrating a gravel road that does not need a back warning;

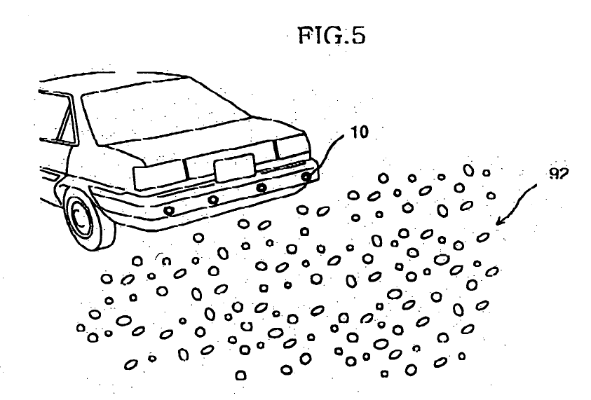

FIG. 6 is a perspective view illustrating an off-road with gravels and soils that do not need a rare warning;

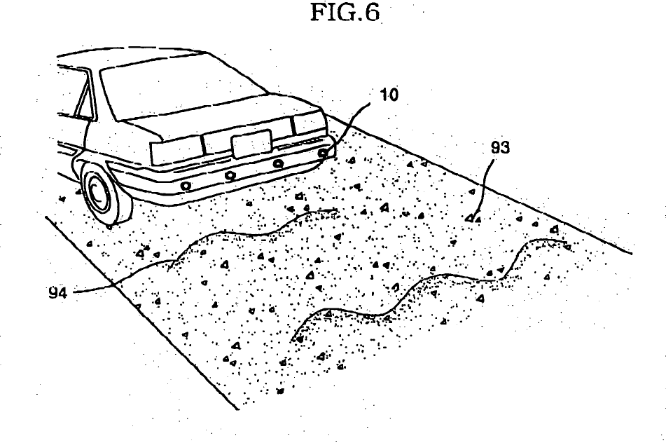

FIG. 7 is a waveform of a road separator detection signal measured in a conventional back warning system for a vehicle;

FIG. 8 is a waveform of a gravel detection signal in a road separator measured in a conventional back warning system for a vehicle;

FIG. 9 is a waveform of a road separator detection signal and a gravel detection signal measured in a conventional back warning system for a vehicle after a tuning work is performed;

FIG. 10 is a block diagram illustrating a back warning system for a vehicle according to the present invention;

FIG. 11 is view illustrating the construction of a reference voltage adjusting register of a central processing unit of FIG. 10;

FIG. 12 is a block diagram of a programmable reference voltage module of FIG. 10;

FIG. 13 is a waveform of a road separator detection signal measured in a back warning system for a vehicle according to the present invention;

FIG. 14 is a waveform of a gravel detection signal in a road separator measured in a back warning system for a vehicle according to the present invention before a tuning work is performed; and

FIG. 15 is a waveform of a gravel detection signal in a road separator measured in a back warning system for a vehicle according to the present invention after a tuning work is performed.

### DETAILED DESCRIPTION OF THE PREFERRED EMBODIMENTS

The preferred embodiments of the present invention will be described with reference to the accompanying drawings.

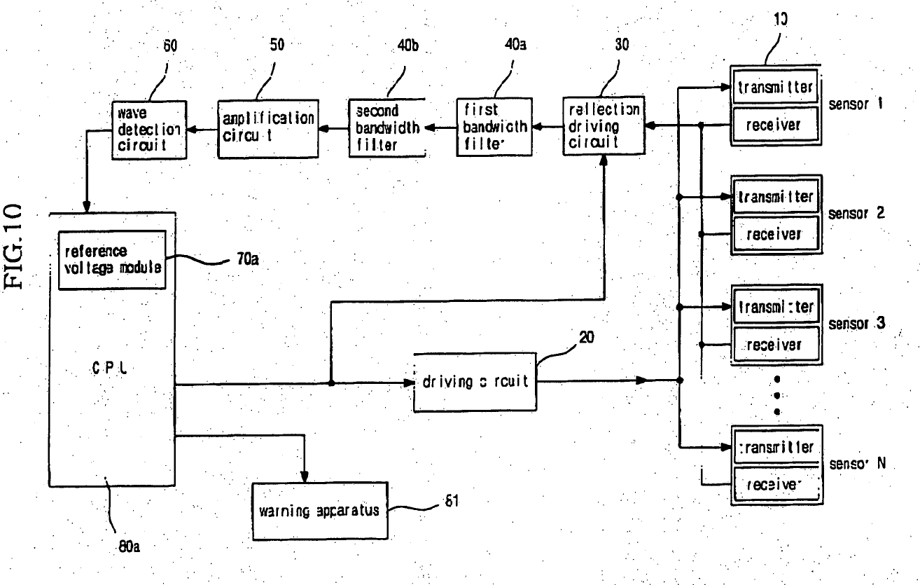

As shown in FIGS. 10 through 12, a plurality of ultrasonic wave sensors 10 are installed in a rear bumper of a vehicle and each is formed of a transmitter capable of radiating an ultrasonic wave based on a driving signal and a receiver capable of receiving a signal reflected from an object.

A driving circuit 20 is configured to transfer a driving signal to each ultrasonic wave sensor 10.

A reflection driving circuit 30 is operated together with the driving circuit 20 and receives a reflection signal from each ultrasonic wave sensor 10.

A first bandwidth filter 40a filters a reflection signal of each ultrasonic wave sensor 10 received by the reflection driving circuit 30 with a certain frequency bandwidth (preferably 40 Khz).

A second bandwidth filter 40b second filers the first filtered reflection signal with the same frequency as the frequency bandwidth of the first bandwidth filter 40a and enhances to a filtering level of the reflection signal.

An amplification circuit 50 amplifies a reflection signal passed through the second bandwidth filter 40b with a certain amplification ratio.

A wave detection circuit 60 wave-detects a reflection signal passed through the amplification circuit 50.

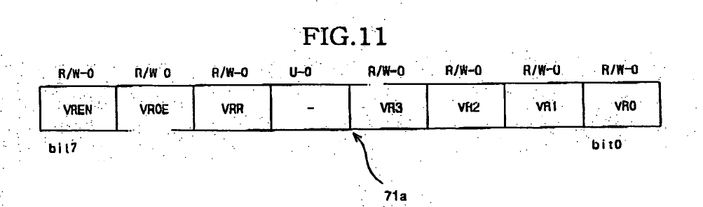

A central processing unit (CPU) 80a includes a reference voltage adjusting register 71a (FIG. 11) having a certain bit number for outputting various program constants for setting various reference voltage values corresponding to an operation time of a timer and an ultrasonic wave sensor 10, and a programmable reference voltage module 70a that outputs various reference voltage values in response to the program constant values from the reference voltage adjusting register 71a. The CPU 80a outputs a driving signal for driving each ultrasonic wave sensor 10 and controls an operation of the driving circuit 20 and the reflection driving circuit 30.

The CPU 80a compares a voltage value of the reflection signal passed through the wave detection circuit 60 with a reference voltage value of the programmable reference voltage module 70a. When the voltage value of the reflection signal is larger than the reference voltage value of the programmable reference voltage module 70a, an object alarm signal is outputted to a warning apparatus 81, and an alarm state is displayed.

A worker can easily change the reference voltage value of the internal programmable reference voltage module 70a of the CPU 80a by changing the program constant values of the reference voltage adjusting register 71a within a range of 0˜3.5V.

The CPU 80a is preferably a PIC16C64X, PIC16C642 or PIC16622 of Microchip Corporation.

For reference, in a 8-bit reference voltage adjusting register 71a of FIG. 11, R mean a readable bit, W means a writable bit, U means an unimplemented bit (read as “0”), VREN of bit 7 means a Vref enable, VORE of bit 6 means a Vref output enable, VRR of bit 5 means Vref range selection, bit 4 means an unimplemented, and VR3-VR0 of bit 3-bit 0 mean Vref value selection.

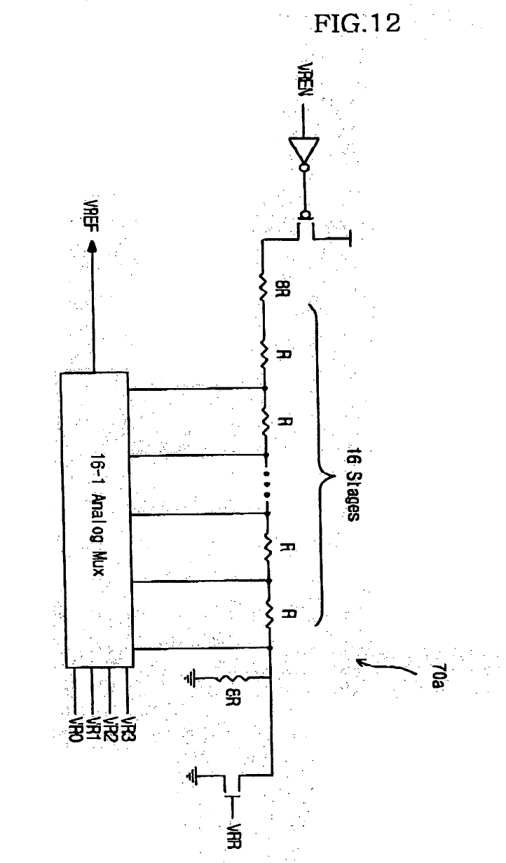

In particular, when VRR of bit 5 is “1”, the reference voltage value of the programmable reference voltage module 70a can be changed to a state of 16 low ranges, and when VRR of bit 5 is “0”, the reference voltage value of the programmable reference voltage module 70a can be changed to 16 high ranges. As shown in FIG. 12, the programmable reference voltage module 70a can output 32 reference voltage values through 16-1 analog multiplexor.

Actually, according to a preferred embodiment of the present invention, the reference voltage value of the internal programmable reference voltage module 70a of the CPU 80a can be changed to 32 levels in a range of 0˜3.5V, respectively, by simply changing the program constant value of the reference voltage adjusting register 71a to 16 low ranges and 16 high ranges by a worker who performs a tuning work.

The operation of the back warning system for a vehicle according to the present invention will be described.

The CPU 80a outputs a driving signal for driving each ultrasonic wave sensor 10 and a signal for operating the driving circuit 20 and the reflection driving circuit 30, respectively. The driving circuit 20 transfers a driving signal to each ultrasonic wave sensor 10.

At this time, each ultrasonic wave sensor 10 radiates ultrasonic waves with respect to a certain object received through the receiver to the reflection driving circuit 30.

The reflection driving circuit 30 transfers a reflection signal from each ultrasonic wave sensor 10 to the first bandwidth filter 40a. The first bandwidth filter 40a filters the reflection signal inputted with a frequency bandwidth of 40 Khz. The second bandwidth filter 40b filters the first filtered reflection signal inputted with a frequency bandwidth of 40 Khz.

When the reflection signal is filtered through the first and second processes in the above manner, the amplification circuit 50 amplifies the reflection signal. The amplified reflection signal is wave-detected by the wave detection circuit 60 and is inputted into the CPU 80a.

At this time, the CPU 80a compares the voltage of the inputted reflection signal with an output reference voltage value of the programmable reference voltage module 70a. As a result of the comparison, when the voltage value of the reflection signal is higher than the output reference voltage value of the programmable reference voltage module 70a, an alarm signal is transferred to the warning apparatus 81 for thereby operating the warning apparatus 81 for thereby informing a driver of a certain obstacle in a rear side of the vehicle.

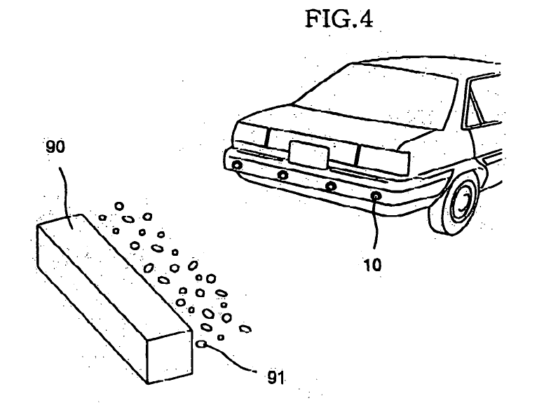

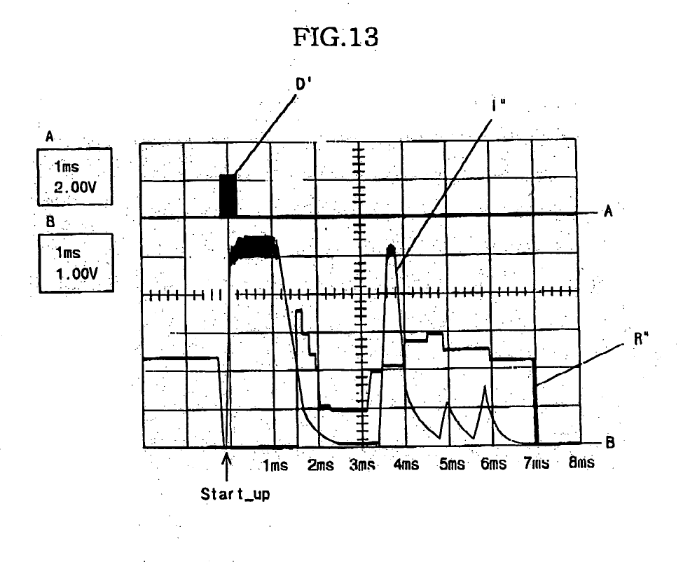

As shown in FIG. 13 with respect to the road stop block 90 of FIG. 4, when a road stop block detection signal waveform (I″) of which the voltage value is larger than the reference signal waveform (R″) of the programmable reference voltage module 70a is inputted into the CPU 80a, the CPU 80a judges that there is a road stop block 90 in a detection range of the ultrasonic wave sensor 10 of the rear side of the vehicle for thereby generating an alarm.

FIG. 13 is an oscilloscope view illustrating a driving signal waveform D′ of the ultrasonic wave sensor 10 of the CPU 80a based on a reference line A having a signal level of 2.00V per 1 ms, a reference signal waveform R″ of the programmable reference voltage module 70a based on a reference line B having a signal level of 1.00V per 1 ms, and an input signal (reflection signal) waveform I″. As shown therein, it is known that it is possible to detect an object after 1.4 ms with respect to the start up time of the ultrasonic wave sensor 10.

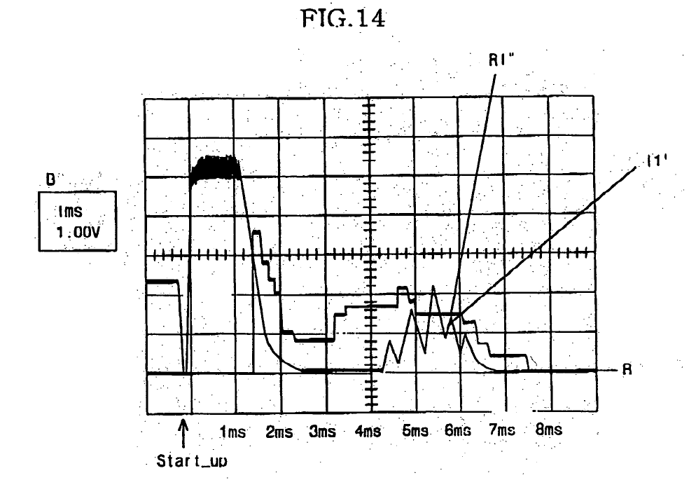

As shown in FIG. 4, when the gravel detection signal waveform I1′, of which the voltage value is even slightly larger than the reference signal waveform R1″ of the programmable reference voltage module 70a as shown in FIG. 14 with respect to the gravel 91 positioned in the road stop block 90 that does not need an alarm of FIG. 4, is inputted, the CPU 80a erroneously judges that there is an obstacle like the road stop block 90 in a detection range of the ultrasonic wave sensor 10 of the rear side of the vehicle for thereby generating an error alarm. As shown in FIG. 14, it is known that the gravel 91 is detected in the road stop block 90 that does not need an alarm at 5 ms through 6 ms with respect to the start up time of the ultrasonic wave sensor 10.

Therefore, in order to overcome the error alarm problems due to the gravel 91 in the road stop block 90 that does not need an alarm, a tuning work should be performed for adjusting the output reference voltage of the programmable reference voltage module 70a.

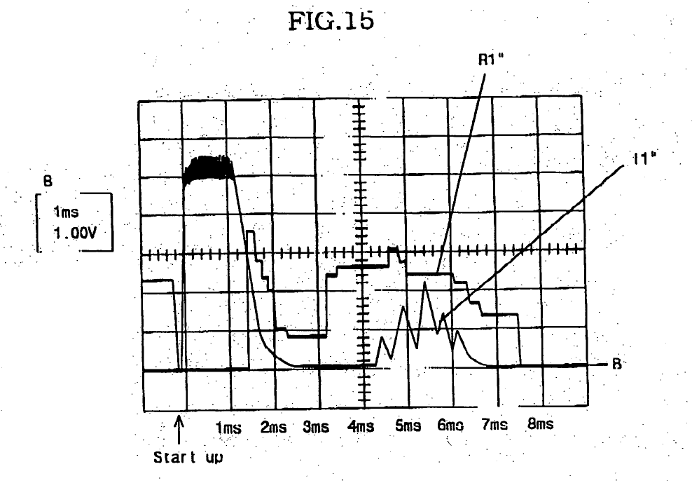

At this time, a certain program constant value is inputted into the reference voltage adjusting register 71a for setting a reference voltage value that is recognizable in response to an operation time of the ultrasonic wave sensor 10 and is applied to the programmable reference voltage module 70a. As shown in FIG. 15, in the above tuning work, the reference voltage value of 5 ms through 6 ms with respect to the start up time of the ultrasonic wave sensor 10 is set higher than the reflection signal value inputted into the CPU 80a at 5 ms through 6 ms with respect to the start up time of the ultrasonic wave sensor 10 FIG. 14.

Therefore, in the tuning work, the output reference voltage value of the programmable reference voltage module 70a is changed by freely changing the input program constant value of the reference voltage adjusting register 71a recognizable in response to the operation time of the ultrasonic wave sensor 10. Therefore, it is possible to overcome the error warning problem due to the gravel 91 in the road stop block 90 that does not need an alarm.

In the present invention, the output reference voltage value of the programmable reference voltage module 70a is changed with 32 levels in a range of 0 through 3.5V based on the change of the program constant value for recognition in response to the operation time of the ultrasonic wave sensor 10 with respect to the road stop block 90, the gravels 91 in the road stop block 90, the gravel road 92, and the gravel 93 or soil 94 in the off road. The above tuning work is performed 10 times in average per day, so that it is possible to complete a desired tuning work with respect to the back warning system for a vehicle.

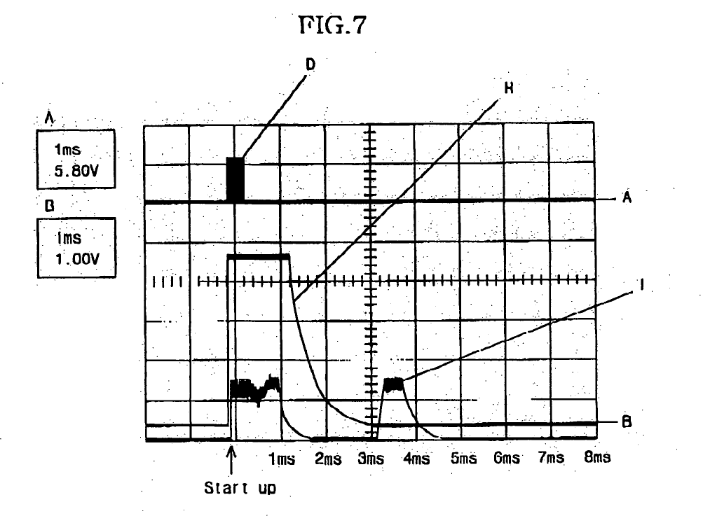

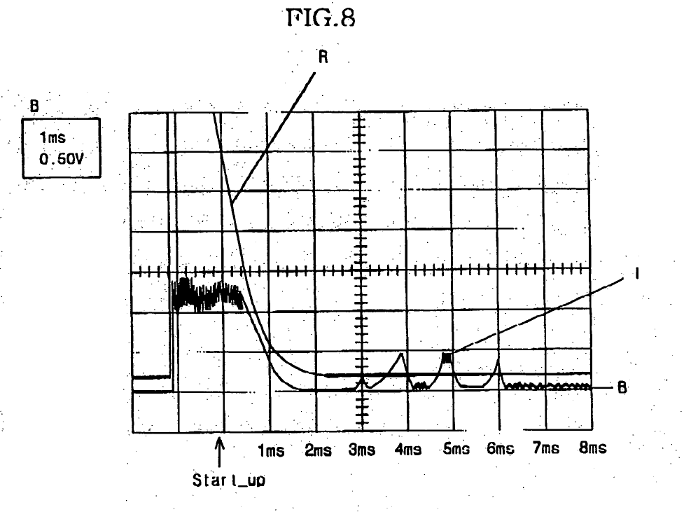

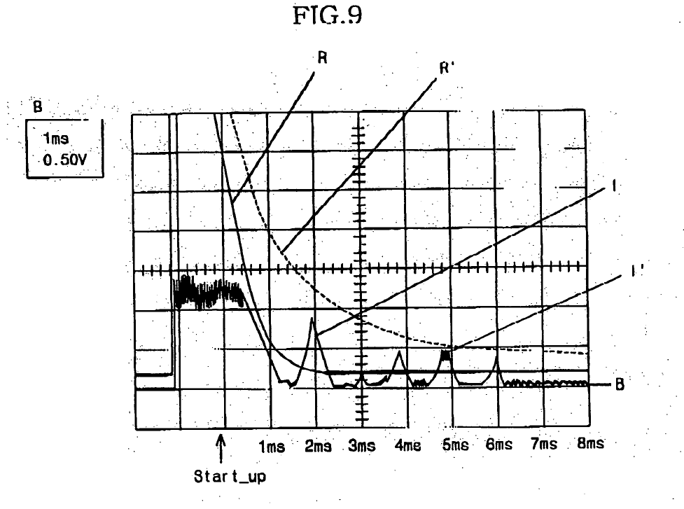

As shown in FIGS. 7 through 9, in the conventional tuning work with respect to the back warning system for a vehicle adapting the external comparator 70 installed independently from the CPU 80, the entire signal levels of the reference signal waveforms are changed by changing the inclination of the time constant number cure. However, as shown in FIGS. 13 and 14, in the present invention adapting the reference voltage adjusting register 71a and the programmable reference voltage module 70a installed in the interior of the CPU 80a, it is not needed to change the entire signal levels of the reference signal waveforms. Namely, in the present invention, only the signal level with respect to a part of the section that needs a tuning work among the reference waveforms is changed for recognition in response to the operation time of the ultrasonic wave sensor 10, so that it is possible to quickly finish the tuning work.

As described above, in the back warning system for a vehicle according to the present invention, the obstacles that need an alarm are fully detected using the internal programmable reference voltage module that is provided in the interior of the CPU and generates various reference voltage values in accordance with the input program constant values, and the tuning work is freely performed for recognizing the obstacles that do not need an alarm. Therefore, in the present invention, it is possible to achieve an excellent tuning work as compared with the conventional back warning system for a vehicle that uses an external comparator installed independently from the CPU. The tuning time is significantly decreased. Actually, it is possible to decrease the tuning period from about 30 days to one day. In addition, in the present invention, it is possible to prevent an error warning that occurs in the conventional back warning system for a vehicle for thereby enhancing the performance of the system in the present invention.

In addition, in the back warning system for a vehicle according to the present invention, since the reflection signal is double filtered with the same frequency bandwidth, the object detection performance is enhanced, and the reliability and performance of the system is enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A back warning system for a vehicle, comprising:
a plurality of ultrasonic wave sensors that are installed in a rear bumper of a vehicle and each are formed of a transmitter capable of radiating ultrasonic waves based on a driving signal and a receiver capable of receiving a signal reflected from an object;
a driving circuit that transfers a driving signal to each ultrasonic wave sensor;
a reflection driving circuit that is operated in cooperation with the driving circuit and receives a reflection signal from each ultrasonic wave sensor;
a first bandwidth filter that filters a reflection signal of each ultrasonic wave sensor received by the reflection driving circuit with a certain frequency bandwidth;
a second bandwidth filter that filters the filtered reflection signal with the same frequency bandwidth as the frequency bandwidth of the first bandwidth filter 40a;
an amplification circuit that amplifies a reflection signal passed through the second bandwidth filter with a certain amplification ratio;
a wave detection circuit that wave-detects a reflection signal passed through the amplification circuit; and
a central processing unit (CPU) that includes a reference voltage adjusting register that outputs various program constant values for setting various reference voltage values for recognition in response to an operation of a timer and the ultrasonic wave sensor, and a programmable reference voltage module that outputs various reference voltage values in response to a program constant value from the reference voltage adjusting register, wherein said CPU outputs a driving signal for driving each ultrasonic wave sensor, and controls the operations of the driving circuit and the reflection driving circuit, and compares a voltage value of the reflection signal passed through the wave detection circuit with a reference voltage value of the programmable reference voltage module, and outputs an object alarm signal to a warning apparatus when the voltage value of the reflection signal is larger than the reference voltage value of the programmable reference voltage module when the voltage value of the reflection signal is higher than the reference voltage value of the programmable reference voltage module as a result of the comparison.

2. The system of claim 1, wherein said internal programmable reference voltage module of the CPU outputs a reference voltage value in 32 levels in a range of 0 through 3.5V in response to a program constant value from the reference voltage adjusting register.
